(19) United States
(12) Patent Application Publication
(10) Pub. No.: US 2026/0284785 A1
(43) Pub. Date: Sep. 24, 2026

(54) METHOD FOR SMOOTHING A SURFACE OF A LAYERED MATERIAL

(71) Applicant: City University of Hong Kong, Hong Kong (CN)

(72) Inventors: Thuc Hue LY, Hong Kong, (CN); Quoc Huy THI, Hong Kong (CN); Lingli HUANG, Hong Kong (CN)

(73) Assignee: City University of Hong Kong, Hong Kong (CN)

(21) Appl. No.: 19/547,051

(22) Filed: Feb. 23, 2026

Related U.S. Application Data
(60) Provisional application No. 63/774,065, filed on Mar. 18, 2025.

(51) Int. Cl. B23K 26/082

(52) U.S. Cl. CPC B23K 26/082

(57) ABSTRACT

The disclosure is directed to a method for smoothing a surface of a two-dimensional (2D) layered material positioned on a substrate, the method comprising: positioning the 2D layered material on a substrate, exposing the 2D layered material and the substrate to an environment that creates a low friction layer between the 2D layered material and the substrate, applying a smoothing process to the surface of the 2D layered material; and, wherein the low friction layer reduces or overcomes van der Waals force between the 2D layered material and the substrate to facilitate removal of wrinkles formed in the 2D layered material. The method is advantageous because it provides a smoothing process that is applicable on a wide range of atomic thick 2D layered materials without any area limitations ranging from nano-to-wafer scale.

The present application claims priority from U.S. Provisional Application No. 63/774,065 filed on Mar. 18, 2025, “A METHOD FOR SMOOTHING A SURFACE OF A LAYERED MATERIAL”, the content of each being hereby incorporated by reference in its entirety.

### TECHNICAL FIELD

The present disclosure relates to nanotechnology. In particular, the present disclosure relates to a method for smoothing a surface of a layered material applied to a substrate.

### BACKGROUND

The van der Waals (vdW) two-dimensional (2D) layered materials such as for example Graphene, Molybdenum Disulfide and transition metal dichalcogenides (TMDs) are promising candidates for high-performance electronic, optoelectronic, and sensing applications owing to their ultrahigh carrier mobility, and fast optical and electrical response. However, the synthesis, transfer, and integration processes used to fabricate various devices introduce unwanted wrinkling and contamination to the surfaces of 2D layered materials due to the natural high surface instability of the atomic-thick layered structure. Wrinkles occurring can reduce localized optical transparency significantly. The presence of wrinkles can also degrade carrier mobility from meso to macroscale.

Applying 2D layered materials is challenging due to wrinkles forming when they are placed on a substrate. The wrinkles or buckling result from the nonuniform strain developed by lattice mismatch, thermal expansion, molecular absorption, and UV irradiation during the synthesis, transfer, and fabrication processes. While some alternative methods are developed for the synthesis and transfer of wrinkle-free 2D materials, they are limited to specific materials and lack compatibility with the common fabrication processes.

On the other hand, the conventional post-treatment of thermal annealing can merely remove small wrinkles height under 1 nm but poses a high risk of introducing more defects to 2D materials. Nevertheless, wrinkles on 2D layered materials that reach a certain length can transform into “clipped wrinkles” stabilized by van der Waals (vdW) interactions, rendering them resistant to heat-induced relaxation.

### SUMMARY OF THE INVENTION

The present disclosure seeks to disclose a method for smoothing a surface of a layered material, which will overcome or substantially ameliorate at least some of the deficiencies of the prior art, or to at least provide an alternative.

The present disclosure relates to a surface treatment method in two-dimensional layered materials when positioned on a substrate. In particular, the present disclosure relates to a surface treatment method for smoothing and removing wrinkles from a nano-to-wafer scale area of a two-dimensional layered material when it is placed on a substrate.

In accordance with a first aspect, there is provided a method for smoothing a surface of a two-dimensional (2D) layered material positioned on a substrate, the method comprising:
positioning the 2D layered material on a substrate,
exposing the 2D layered material and the substrate to an environment that creates a low friction layer between the 2D layered material and the substrate,
applying a smoothing process to the surface of the 2D layered material; and,
wherein the low friction layer reduces or overcomes van der Waals force between the 2D layered material and the substrate to facilitate removal of wrinkles formed in the 2D layered material.

The method is advantageous because it provides a smoothing process that is applicable on a wide range of atomic thick 2D layered materials without any area limitations ranging from nano-to-wafer scale.

In one example, the environment that creates the low friction layer is an environment with a relative humidity sufficient to intercalate water molecules between the 2D layered material and the substrate.

In one example, the environment is at a temperature sufficient to freeze the intercalated water molecules into an ice layer confined between the 2D layered material and the substrate.

In one example, the method comprising the steps of:
placing the 2D layered material and the substrate in an environment control chamber,
introducing moisture into the environment control chamber to establish a relative humidity sufficient to intercalate the water molecules between the 2D layered material and the substrate,
cooling the 2D layered material from a first temperature to a second temperature to freeze the intercalated water molecules into a confined ice layer at an interface between the 2D layered material and the substrate; and, wherein the second temperature is a cryogenic temperature.

The method is advantageous as it works in high humidity and at low temperatures e.g., cryogenic temperatures which can avoid the risk of introducing defects due to high thermal energy.

In one example, introducing moisture comprises introducing a wet nitrogen gas into the environment control chamber to control the relative humidity in the environment control chamber; and, wherein the relative humidity established in the environment control chamber is in the range of 50% to 100%; and, the 2D layered material and the substrate are maintained in the environment with relative humidity for a period of time sufficient to ensure intercalation of water molecules into an interface between the 2D layered material and the substrate.

In one example, the wet nitrogen gas is introduced into the environment control chamber at a flow rate in a range of 0.05 L/min to 1 L/min; and, the method further comprises maintaining the 2D layered material in the relative humidity level for between 10 minutes to 3 hours to intercalate water molecules between the 2D layered material and the substrate.

In one example, the cryogenic temperature is in the range of 0° C. to −250° C. or 0° C. to −50° C.

In one example, the step of cooling is performed at a cooling rate in a range of 1° C./min to 4° C./min.

In one example, the smoothing process comprises moving a solid probe over a target area of the surface of the 2D layered material to apply a mechanical force to the 2D layered material.

In one example, the mechanical force applied by the solid probe is in the range of 1 nN to 100 nN; and, wherein the solid probe is moved at a speed in range of 2 μm/s to 10 μm/s.

In one example, the solid probe is selected from a group consisting of silicon probe, diamond probe or a metal-coated silicon probe.

In one example, the target area for moving the solid probe is in the range of 1 nm² to 100 μm².

In one example, the smoothing process comprises irradiating a target area of the surface of the 2D layered material with a laser.

In one example, the laser is applied with a power in a range of 0.5 mW to 15 mW, wherein the laser is scanned across the surface at a speed in a range of 0.5 μm to 2 μm on the surface of the 2D layered material; and, wherein the target area for irradiating with the laser ranges from 0.5 μm² to a full wafer scale.

In one example, the smoothing process is selected based on a size of a target area that requires smoothing, wherein a solid probe based smoothing process is selected for a target area of less than 100 μm² and a laser irradiation based smoothing process is selected for target areas of greater than 1 μm².

In one example, the method eliminates 100% of wrinkles on the surface of the 2D layered material positioned on the substrate.

In one example, the method comprises the step of selecting one of two smoothing processes based on a size of target area that requires smoothing, wherein a first smoothing process applies a mechanical force to the target area, and a second smoothing process applies thermal irradiation to the target area.

In one example, the method comprises the steps of: selecting one of two smoothing processes based on a size of target area that requires smoothing, wherein a first smoothing process applies a mechanical force to the target area, and a second smoothing process applies thermal irradiation to the target area; and, applying the selected smoothing process to the surface of the 2D layered material.

In one example, wherein applying the smoothing process to the surface of the 2D layered material causes removal of one or more wrinkles from the surface of the 2D layered material.

In one example, the wavelength of the laser used in laser irradiation is in the range of visible to near IR, the wavelength being between 400 nm to 800 nm.

In accordance with a second aspect, there is provided a method for smoothing a surface of a two-dimensional (2D) layered material positioned on a substrate, the method comprising:
positioning the 2D layered material on a substrate,
placing the 2D layered material and the substrate in an environment control chamber,
introducing moisture into the environment control chamber to establish a relative humidity sufficient to intercalate the water molecules between the 2D layered material and the substrate,
cooling the 2D layered material from a first temperature to a second temperature to freeze the intercalated water molecules into a confined ice layer at an interface between the 2D layered material and the substrate, wherein the second temperature is a cryogenic temperature,
wherein the ice layer defines a low friction layer between the 2D layered material and the substrate,
selecting one of two smoothing processes based on a size of target area that requires smoothing, wherein a first smoothing process applies a mechanical force to the target area, and a second smoothing process applies thermal irradiation to the target area,
applying the selected smoothing process to the surface of the 2D layered material; and,
wherein the low friction layer reduces or overcomes van der Waals force between the 2D layered material and the substrate to facilitate removal of wrinkles formed in the 2D layered material.

In one example, the first smoothing process comprises moving a solid probe over a target area of the surface of the 2D layered material to apply a mechanical force to the 2D layered material, and the second smoothing process comprises irradiating a target area of the surface of the 2D layered material with a laser to induce thermal relaxation; and, wherein a solid probe based smoothing process is selected for a target area of less than 100 μm² and a laser irradiation based smoothing process is selected for target areas of greater than 1 μm².

In one example, the mechanical force applied by the solid probe is in the range of 1 nN to 100 nN; and, wherein the solid probe is scanned at a speed in range of 2 μm/s to 10 μm/s; and, wherein the laser is applied with a power in a range of 0.5 mW to 15 mW, wherein the laser is scanned across the surface at a speed in a range of 0.5 μm to 2 μm on the surface of the 2D layered material; and, wherein the target area for irradiating with the laser ranges from 0.5 μm² to a full wafer scale.

In one example, introducing moisture comprises introducing a wet nitrogen gas into the environment control chamber to control the relative humidity in the environment control chamber; and, wherein the relative humidity established in the environment control chamber is in the range of 50% to 100%; and, the 2D layered material and the substrate are maintained in the environment with relative humidity for a period of time sufficient to ensure intercalation of water molecules into an interface between the 2D layered material and the substrate, wherein the wet nitrogen gas is introduced into the environment control chamber at a flow rate in a range of 0.05 L/min to 1 L/min; and, the method further comprises maintaining the 2D layered material in the relative humidity level for between 10 minutes to 3 hours to intercalate water molecules between the 2D layered material and the substrate, wherein the cryogenic temperature is in the range of 0° C. to −250° C. or 0° C. to −50° C.; and, wherein the step of cooling is performed at a cooling rate in a range of 1° C./min to 4° C./min.

According to a further aspect, there is provided a method for scalable smoothing surface of 2D layered materials using probe scanning (i.e., probe moving) and laser irradiation at high humidity and cryogenic temperature includes the following steps:
S1. A sample of 2D layered materials on substrates is put in an environment control chamber.
S2. Wet nitrogen gas is inserted to control the relative humidity (RH) of the environment inside the chamber.
S3. The sample is set in the high humidity environment for a certain time to intercalate water molecules into the interface between thin films and substrates.
S4. Cool down the sample from room temperature to cryogenic temperature to freeze the water molecules to the ice layer confined between 2D layered materials and substrates.
S5. According to the size of the required smoothing area, the following steps will be applied:
   S5.1. Size from 1 nm² to 100 μm²: a probe approach to the surface of 2D layered materials and scan over the required smoothing area to eliminate wrinkles and contaminants at the same time.
   S5.2. Size from 1 μm² to the whole wafer: the required smoothing area is exposed to the visible-range laser to eliminate wrinkles.

The sample size in step S1 is non-limited and depends on the capability of the environment control chamber.

In one example, the flow rate of wet nitrogen gas inserted in step S2 is 0.1-0.5 L/min.

In one example, the environment relative humidity in the chamber in step S2 is 50-100%.

In one example, the treatment time in step S3 is in the range of 15 min to 2 hours.

In one example, the cooling rate in step S4 is in the range of 1 to 2° C./min.

In one example, the cooling target temperature in step S4 is in the range of 0 to −40° C.

In one example, the force between the nano-probe and the target surface in step S5.1 is in the range of 1 to 100 nN.

In one example, the probe radius used in step S5.1 is in the range of 5 nm to 10 μm.

In one example, the scanning speed of the probe on the target surface in step S5.1 is in the range of 2 to 10 μm/s.

In one example, the probe used in step S5.1 is silicon probe, metal-coated silicon probe, and diamond probe.

In one example, the power of laser irradiation in step S5.2 is in the range of 1 to 10 mW. Preferably, the wavelength of laser irradiation in step S5.2 is in the range of visible to near IR including, but not limited to, 514, 633, and 785 nm.

In one example, the focus beam size of the laser on the surface in step S5.2 is in the range of 0.5 to 2 μm.

In one example, the scanning speed of the laser in step S5.2 is in the range of 2 to 100 μm/s.

The term “comprising” (and its grammatical variations) as used herein are used in the inclusive sense of “having” or “including” and not in the sense of “consisting only of”.

It is to be understood that, if any prior art information is referred to herein, such reference does not constitute an admission that the information forms a part of the common general knowledge in the art.

### BRIEF DESCRIPTION OF THE DRAWINGS

Embodiments of the present invention will now be described, by way of example, with reference to the accompanying drawings in which:

FIG. 1 illustrates a method for smoothing a surface of a two-dimensional (2D) layered material positioned on a substrate according to one embodiment of the present invention.

FIG. 2 illustrates a method for smoothing a surface of a two-dimensional (2D) layered material positioned on a substrate according to a further embodiment of the present invention.

FIG. 3A illustrates a schematic of a first smoothing process that is applied as part of a method for smoothing a surface of a two-dimensional (2D) layered material positioned on a substrate.

FIG. 3B illustrates a schematic of a second smoothing process that is applied as part of a method for smoothing a surface of a two-dimensional (2D) layered material positioned on a substrate.

FIG. 4 shows the atomic force microscope (AFM) topographic images of pristine (a) graphene, (b) 2H phase molybdenum disulfides (2H-MoS₂), and (c) hexagonal boron nitrides (h-EN); and the AFM topographic images of (d) graphene, (e) MoS₂, (f) h-BN after smoothed using probe scanning at cryogenic temperature.

FIG. 5A illustrates a dark-field optical image of a full film single layer graphene smoothed using probe scanning (probe movement) at cryogenic temperatures.

FIG. 5B illustrates a bright-field optical microscope image a full film single layer graphene smoothed using probe scanning (probe movement) at cryogenic temperatures.

FIG. 5C illustrates a scanning electron microscope image of a full film single layer graphene smoothed using probe scanning (probe movement) at cryogenic temperatures.

FIG. 6 shows the AFM topographic image of distorted 1T′ phase rhenium disulfides (1T″-ReS₂) with wrinkles and a target area smoothed by laser irradiation at cryogenic temperature.

FIG. 7A shows the scanning electron microscope (SEM) of different flattened areas on the full-film 1T″-ReS₂.

FIG. 7B illustrates a zoomed in AFM topographic image of the edge between the flattened and the pristine surface.

FIG. 8 shows a plot of summarized root mean square (RMS) roughness of the pristine surface and the surface after smoothing of various 2D layered materials.

FIG. 9A illustrates, electronic performance of a smoothed device as compared to a control (pristine) 2H phase molybdenum disulfides (2H-MoS₂) field-effect transistor (FET) device.

FIG. 9B illustrates, electronic performance of a smoothed device as compared to a control (pristine) 2H-MoS₂ FET device.

FIG. 10A illustrates electrical characteristics of this smoothed device as compared to a control (pristine) distorted 1T′ phase rhenium disulfides (1T″-ReS₂) field-effect transistor (FET) device.

FIG. 10B illustrates electrical characteristics of this smoothed device as compared to a control (pristine) 1T″-ReS₂ FET device.

FIG. 11A illustrates optical characteristics of the smoothed device as compared to a control (wrinkled) distorted 1T′ phase rhenium disulfides (1T″-ReS₂) device.

FIG. 11B illustrates optical characteristics of the smoothed device as compared to a control (wrinkled) 1T″-ReS₂ device.

### DETAILED DESCRIPTION OF THE PREFERRED EMBODIMENT

The present disclosure relates to a method for smoothing surface of a 2D layered material applied to a substrate.

Two dimensional (2D) layered materials are ultra-thin solids composed of one or a few layers and are applied to a substrate e.g., a substrate of semiconductor material. Each layer may be one atom thick. Alternatively, some layers may be a few atoms thick. These materials often possess unique electronic, mechanical and/or optical properties, making them critical for applications in flexible electronics, optoelectronics, energy storage and sensing.

Due to their properties, 2D layered materials can be used in electronics (e.g., transistors, sensors, and flexible, transparent conductors) and energy applications (e.g., high-performance batteries, supercapacitors, and energy harvesting). Other applications are also contemplated. Some examples of 2D layered materials are Graphene, Hexagonal Boron Nitride (h-BN), Phosphorene, Molybdenum Disulfide (MoS₂) or other Transition Metal Dichalcogenides (TMDs). These 2D layered materials are typically arranged in stacked, separable sheets, allowing them to be isolated into single monolayers. Each sheet may be one to a few atoms thick.

2D layered materials are applied in a very thin layer to a substrate. These materials are often so thin, they have very little bending stiffness. When placed on a substrate, these 2D layered materials often can adhere to itself or to the substrate due to van der Waals forces (i.e., molecular attraction). Once a wrinkle forms, the friction between the substrate and the 2D layered material can increase significantly. Attempting to push the wrinkle out can cause the 2D layered material to tear or get damaged, or the wrinkle moves slightly and gets stuck again.

The static friction between the substrate and the 2D layered material is too high to allow the material to relax into a flat state, thereby causing wrinkles. Wrinkles in the fabricated device that includes a substrate and a 2D layered material can reduce localized optical transparency significantly, e.g., in some cases by more than 200% compared to flat and clean surfaces. The presence of wrinkles can also degrade carrier mobility resulting in a more inferior product. These irregularities also undermine the wafer-scale uniformity necessary for the industrial manufacturing of high-performance integrated electronic, optoelectronic devices, and sensors.

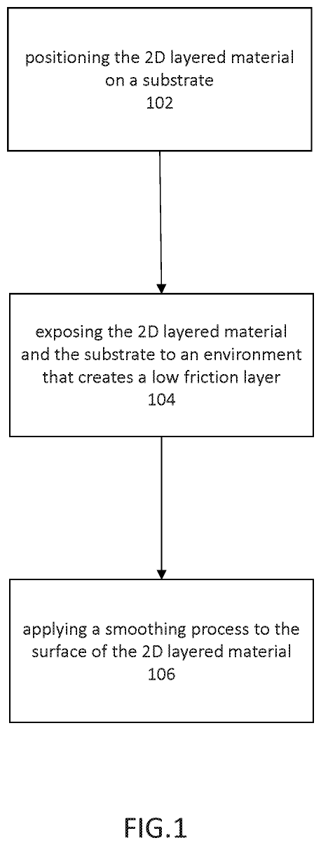

Referring to FIG. 1, an embodiment of the present invention is illustrated. This embodiment is arranged to provide a method 100 for smoothing a surface of a two-dimensional (2D) layered material 10 positioned on a substrate. The method comprises a plurality of steps to smooth a surface of a 2D layered material positioned on a substrate 12. Step 102 comprises positioning the 2D layered material on a substrate. Step 104 comprises exposing the 2D layered material and the substrate to an environment that creates a low friction layer between the 2D layered material and the substrate. Step 106 comprises applying a smoothing process to the surface of the 2D layered material. The low friction layer reduces or overcomes van der Waals force between the 2D layered material and the substrate to facilitate removal of wrinkles formed in the 2D layered material.

The method is advantageous because it provides a smoothing process that is applicable on a wide range of atomic thick 2D layered materials without any area limitations ranging from nano-to-wafer scale.

The environment that creates the low friction layer is an environment with a relative humidity sufficient to intercalate water molecules between the 2D layered material and the substrate. The environment is at a temperature sufficient to freeze the intercalated water molecules into an ice layer confined between the 2D layered material and the substrate. The environment may be formed in an environment chamber that is temperature and humidity controlled. The ice layer may act as the low friction layer. The low friction layer can overcome van der Waals forces between the 2D layered materials and substrate. The low friction layer can also reduce van der Waals forces between adjacent portions of the 2D layered materials.

In one example, ice functions as the low friction layer. In other examples, other material may be used to create a low friction layer.

The method 100 comprises placing the 2D layered material and the substrate in an environment control chamber, introducing moisture into the environment control chamber to establish a relative humidity sufficient to intercalate the water molecules between the 2D layered material and the substrate; and, cooling the 2D layered material from a first temperature to a second temperature to freeze the intercalated water molecules into a confined ice layer at an interface between the 2D layered material and the substrate; and, wherein the second temperature is a cryogenic temperature.

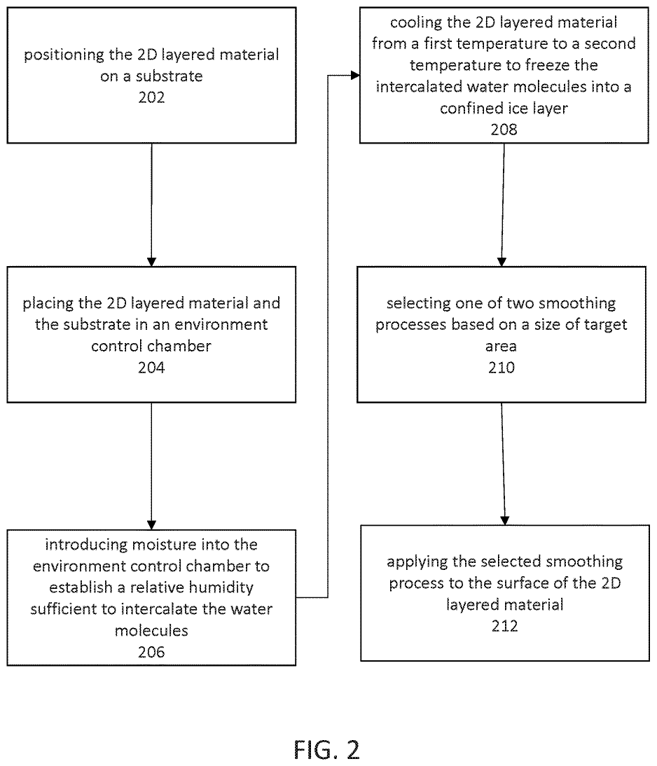

FIG. 2 illustrates a further embodiment of a method 200 for smoothing a surface of a two-dimensional (2D) layered material positioned on a substrate. The method illustrated in the method 200 may be a more detailed example of a method for smoothing a surface of a 2D layered material. The method 200 comprises a plurality of steps as shown in FIG. 2. Step 202 comprises positioning the 2D layered material 304 on a substrate 302. Step 204 comprises placing the 2D layered material 304 and the substrate 302 in an environment control chamber. Step 206 comprises introducing moisture into the environment control chamber to establish a relative humidity sufficient to intercalate the water molecules between the 2D layered material and the substrate. Step 208 comprises cooling the 2D layered material from a first temperature to a second temperature to freeze the intercalated water molecules into a confined ice layer 306 at an interface between the 2D layered material 304 and the substrate 302. Optionally the second temperature is a cryogenic temperature. The ice layer 306 defines a low friction layer between the 2D layered material and the substrate. Step 210 comprises selecting one of two smoothing processes based on a size of target area that requires smoothing. A first smoothing process 310 applies a mechanical force to the target area, and a second smoothing process 320 applies thermal irradiation to the target area. Step 212 comprises applying the selected smoothing process to the surface of the 2D layered material. The low friction layer reduces or overcomes van der Waals force between the 2D layered material and the substrate to facilitate removal of wrinkles formed in the 2D layered material.

In one example, introducing moisture comprises introducing a wet nitrogen gas into an environment control chamber to control the relative humidity in the environment control chamber. The relative humidity established in the environment control chamber is in the range of 50% to 100%. The 2D layered material and the substrate are maintained in the environment with relative humidity for a period of time sufficient to ensure intercalation of water molecules into an interface between the 2D layered material and the substrate.

The wet nitrogen gas may be introduced into the environment control chamber at a flow rate in a range of 0.05 L/min to 1 L/min. The 2D layered material and substrate may be maintained in the relative humidity level for between 10 minutes to 3 hours to intercalate water molecules between the 2D layered material and the substrate. In one example, the 2D layered material and substrate may be maintained in the high humidity environment (e.g., 100% relative humidity) for between 15 mins to 2 hours in order to allow water molecules to intercalate at an interface between the 2D layered material and the substrate (i.e., intercalate water molecules between the 2D layered material and the substrate).

In one example, the size of the sample of the 2D layered material and the substrate may be any suitable size and depends on the capability of an environment control chamber.

The cryogenic temperature may be in the range of 0° C. to −250° C. or 0° C. to −50° C. In a further example, the cryogenic temperature may be in the range of 0° C. to −40° C. in one example, the step of cooling is performed at a cooling rate in a range of 1° C./min to 4° C./min.

In one example, the first smoothing process comprises moving a solid probe over a target area of the surface of the 2D layered material to apply a mechanical force to the 2D layered material. In one example, the second smoothing process comprises irradiating a target area of the surface of the 2D layered material with a laser.

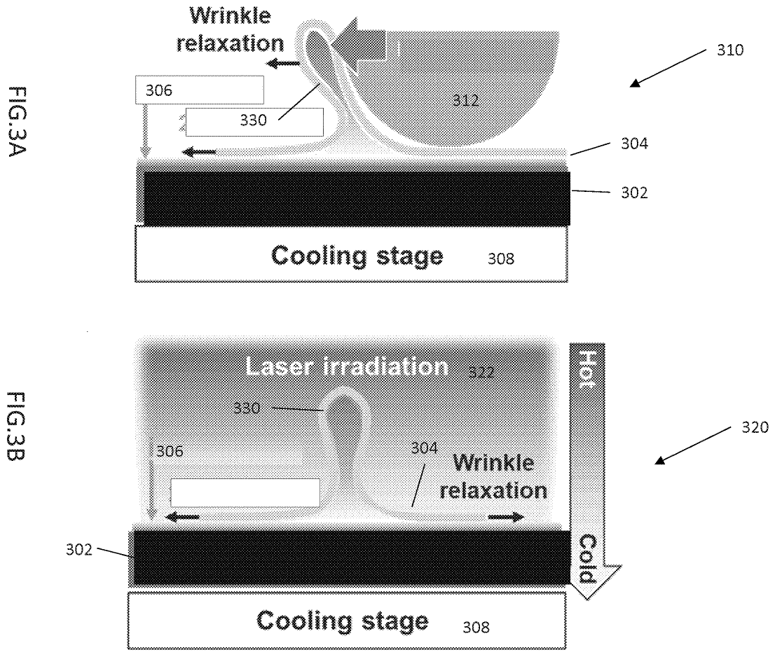

FIG. 3A illustrates a schematic illustrating the two smoothing processes i.e., mechanisms of smoothing wrinkles on the surface of 2D materials using (FIG. 3A) probe movement (i.e., probe scanning) and (FIG. 3B) laser irradiation. As shown FIG. 3A, the substrate 302 includes a layer of 2D layered material 304 positioned on the substrate 302. The low friction layer 306 (i.e., the ice layer 306) is located between the substrate 302 and the 2D layered material 304 i.e., the ice layer 306 is located at an interface between the substrate 302 and 2D layered material 304.

Referring to FIG. 3A and FIG. 3B cooling stage defines a structure that creates a cryogenic temperature in the environmental chamber. The cooling stage may be a cold block 308 that may cool the substrate to cryogenic temperature. Alternatively, the environment control chamber may be cooled to a cryogenic temperature.

FIG. 3A illustrates the first smoothing process 310. As shown in FIG. 3A the first smoothing process involves moving (i.e., scanning) a mechanical probe 312 across the surface of the 2D layered material to push away a wrinkle 330 and smooth out the 2D layered material. The solid probe 312 exerts a mechanical force on the wrinkle to allow wrinkle relaxation.

The mechanical force applied by the solid probe is in the range of 1 nN to 100 nN; and, wherein the solid probe 312 is moved at a speed in range of 2 μm/s to 10 μm/s. The solid probe is selected from a group consisting of silicon probe, diamond probe or a metal-coated silicon probe. The solid probe may include a circular contact surface, as shown in FIG. 3A. The probe 312 may comprise a radius in the range of 5 nm to 10 μm.

In one example, the target area for moving the solid probe is in the range of 1 nm² to 100 μm².

FIG. 3B illustrates the second smoothing process 320. As shown in FIG. 3B thermal irradiation of the 2D layered material 304 and the substrate 302. The thermal irradiation may be applied by exposing the substrate 302 and the 2D layered material 304 by a laser 322. The laser irradiation allows wrinkle relaxation as shown in FIG. 3B. the laser 322 may be scanned (i.e., moved) over a target area to smooth out wrinkles.

The laser may be applied with a power in a range of 0.5 mW to 15 mW. Preferably the power of the laser may be in the range of 1 to 10 mW. The wavelength of laser irradiation is in the range of visible to near IR including, but not limited to, 514, 633, and 785 nm. The laser is scanned across the surface at a speed in a range of 0.5 μm to 2 μm on the surface of the 2D layered material; and, wherein the target area for irradiating with the laser ranges from 0.5 μm² to a full wafer scale.

The specific smoothing process 310 or 320 may be selected based on a size of a target area that requires smoothing, wherein a solid probe based smoothing process is selected for a target area of less than 100 μm² and a laser irradiation based smoothing process is selected for target areas of greater than 1 μm².

In one example, the method 100 or 200 may comprise applying both smoothing processes 310, 320. The first smoothing process 310 may be applied first to apply a mechanical force to smooth wrinkles. Following the first smoothing process a second smoothing process 320 may be applied to smooth wrinkles by applying thermal irradiation. In a further alternative example, the method of smoothing a surface of a 2D layered material 100, 200 may comprise applying both smoothing processes 310, 320 simultaneously to smooth out wrinkles in a surface of the 2D layered material on the substrate.

The inherent wrinkling of 2D layered materials from the synthesis, transfer, and fabrication processes is a critical bottleneck for high-performance electronic, optoelectronic, and sensing applications. Some alternative methods are developed for the synthesis and transfer of wrinkle-free 2D materials, but they are limited to specific materials and lack compatibility with the common fabrication processes. On the other hand, the conventional post-treatment of thermal annealing can merely remove small wrinkles height under 1 nm but poses a high risk of introducing more defects to 2D materials. Nevertheless, wrinkles on 2D layered materials that reach a certain length can transform into “clipped wrinkles” stabilized by van der Waals (vdW) interactions, rendering them resistant to heat-induced relaxation.

The method 100, 200 may eliminate 100% of wrinkles on the surface of the 2D layered material positioned on the substrate. Alternatively, the method 100, 200 when applied may eliminate most wrinkles e.g., over 85% wrinkles may be removed. The smoothing process applied removes wrinkles from the surface of the 2D layered material.

This method 100, 200 can eliminate 100% of wrinkles on a wide range of atomic-thick 2D layered materials without area limitations ranging from nano- to wafer-scale. The smoothing process works in high humidity at cryogenic temperature which can avoid the risk of introducing defects due to high thermal energy. Moreover, the method 100, 200 can be flexibly integrated into different synthesis, transfer, and processing of 2D layered materials to maintain the smoothness of the final products.

The key to successfully removing wrinkles of 2D layered materials on substrates is to overcome the friction caused by the van der Waals (vdW) interplay between 2D layered materials and underlying substrates. The frictionless 2D confined ice layer is spontaneously generated from the high humidity environment at the interface that can reduce friction between the 2D layered materials and underlying substrates. The low friction layer e.g., the ice layer reduces friction between the 2D layered material and the substrate at their interface. The low friction layer e.g., the ice layer helps to overcome friction due to vdW forces between the 2D layered material and the substrate.

Under the support of the confined ice layer, wrinkles can be easily removed by a minimal external force applied via a nano-solid probe scanning over the surface and/or external strain from rapid thermal relaxation via laser irradiation. The cryogenic temperature promotes the generation of 2D confined ice layers and enhances thermal relaxation under laser irradiation. The low friction layer e.g., the ice layer may be retained during and after the smoothing process has been completed.

In one optional example, the low friction layer may be removed by an appropriate process.

This method proposes using a solid probe moving (i.e., scanning) for nano- to micro-scale wrinkle flattening and laser irradiation for micro- to wafer-scale wrinkle flattening in cryogenic temperature. The method of smoothing as described is applicable to smoothing wrinkles on a wide range of atomic-thick 2D layered materials including, but not limited to, graphene, transition metal dichalcogenides (TMDs) including 2D phase molybdenum disulfides (2H-MoS₂) and distorted 1T′ phase rhenium disulfides (1T″-ReS₂), and hexagonal boron nitrides (h-EN). Moreover, the invention can adapt and integrate into the general transfer and processing of 2D layered materials.

Application of the method 100, 200 and a specific smoothing method may restore an Ohmic contact between the 2D layered material and a metal electrode by mitigating localized strain near a contact interface.

To enable better understanding the technical solutions of the present invention, the present invention will be further described in detail below in conjunction with examples.

In one example, the substrate (or substrates) may be prepared by different methods including, but not limited to, direct bottom-up synthesis, top-down exfoliation, wet and dry transfer, polymer-aided transfer, and ice-aided transfer.

The method 100, 200 for smoothing a surface of 2D layered material positioned on a substrate may be integrated into different device fabrication processes which can cause unwanted wrinkles, including, but not limited to, materials transfer and patterning, electrodes patterning, photoresist coating, developing and removing, thermal and chemical treatments, reactive-ions etching, to maintain the smoothness of final devices.

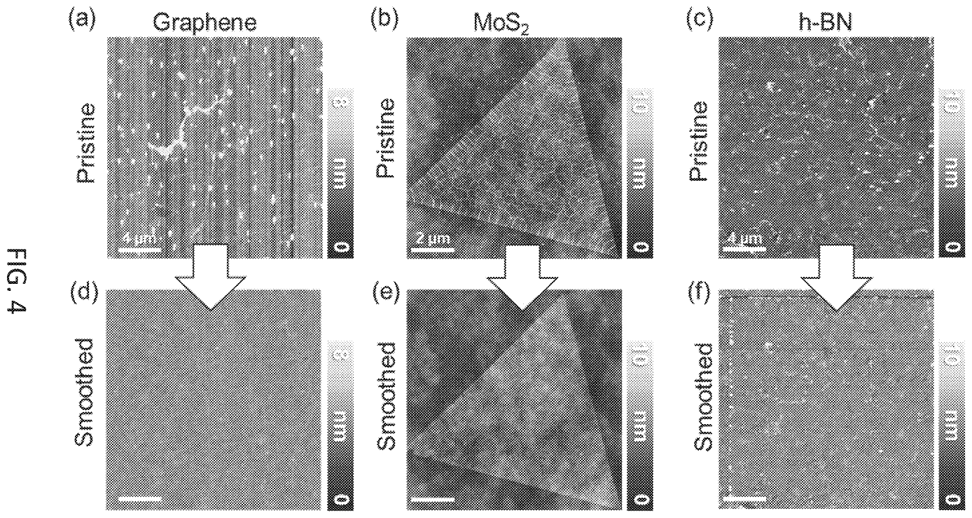

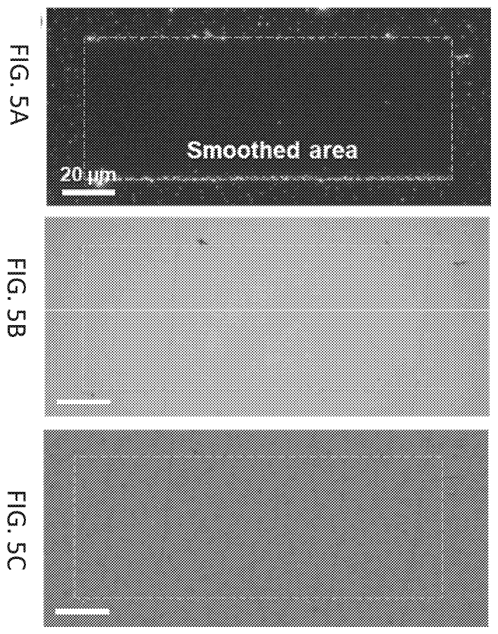

FIG. 4 shows the atomic force microscope (AFM) topographic images of pristine (a) graphene, (b) 2H phase molybdenum disulfides (2H-MoS₂), and (c) hexagonal boron nitrides (h-EN); and the AFM topographic images of (d) graphene, (e) MoS₂, (f) h-BN after smoothing using probe scanning at cryogenic temperature. FIG. 5A illustrates the dark-field, FIG. 5B illustrates the bright-field optical microscope, and FIG. 5C and scanning electron microscope images of full-film single-layer graphene smoothed using probe scanning at cryogenic temperature.

### Example 1

Place a full-film single-layer graphene on the silicon dioxide (SiO₂) substrate as shown in FIG. 4 (a). The graphene layer and substrate are placed into an environment control chamber with a relative humidity (RH) level of 100% for 2 hours. The sample is cooled down with a cooling speed of 1° C./min to −10° C. A probe is approached onto the surface of graphene. Scan (i.e. move) the probe to the desired area with a speed of 10 um/s to smooth the surface of single-layer graphene. The smoothed single layer of graphene is shown in FIG. 4 (d) and FIG. 5A. As can be seen in FIG. 4 (d) and FIG. 5C the wrinkles are removed from the graphene layer. FIGS. 5A and 5B also illustrate the wrinkles removed from the surface of the graphene.

### Example 2

Place a single-layer 2H phase molybdenum disulfides (2H-MoS₂) on the SiO₂ substrate as shown in FIG. 4 (b). Place the substrate and 2H-MoS₂ single-layer into the environment control chamber with a relative humidity (RH) level of 100% for 15 min. Cool down the sample with a cooling speed of 1° C./min to −10° C. Approach a probe onto the surface of MoS₂. Move (i.e. scan) the probe to the desired area with a speed of 2 um/s to smooth the surface of single-layer MoS₂ as shown in FIG. 4 (e).

### Example 3

Put a full-film single-layer hexagonal boron nitride (h-EN) on the SiO₂ substrate as shown in FIG. 4 (c). Place the substrate and h-BN single layer into the environment control chamber with a relative humidity (RH) level of 100% for 2 hours. Cool down the sample with a cooling speed of 1° C./min to −10° C. Approach a probe onto the surface of h-EN. Scan the probe to the desired area with a speed of 10 um/s to smooth the surface of single-layer h-BN as shown in FIG. 4 (f).

### Example 4

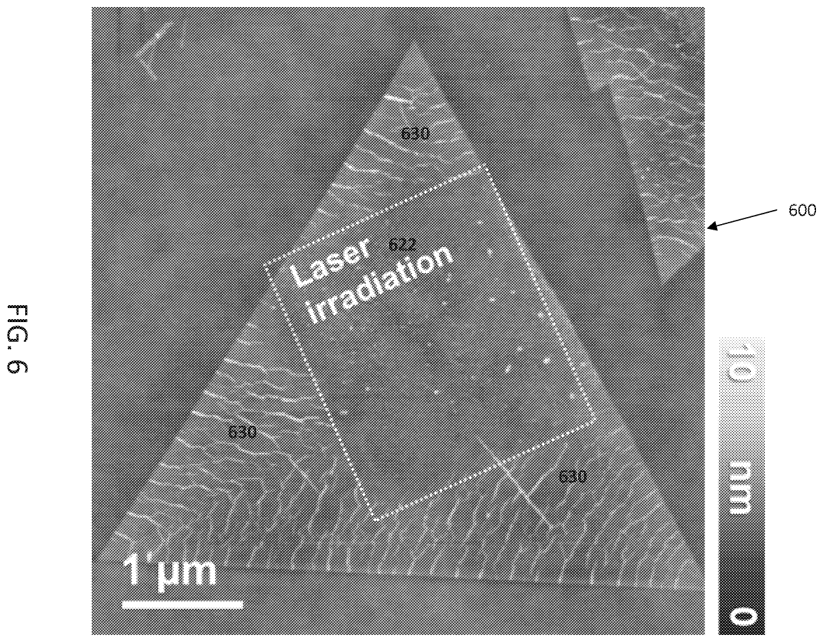

Place a single-layer of distorted 1T′ phase rhenium disulfides (1T″-ReS₂) on the mica substrate, and place both into the environment control chamber with a relative humidity (RH) level of 50-80%. Position the substrate and single-layer of 1T″-ReS₂ under UV light for 180 seconds to mimic the photolithography process. Cool down the sample with a cooling speed of 2° C./min to −40° C. Focus a 514-nm laser beam onto the surface of ReS₂. Scan (i.e., move) the focused laser beam 622 to the desired area with a speed of 0.5 um/s to smooth the surface of single-layer ReS₂ as shown in FIG. 6. FIG. 6 shows the AFM topographic image 600 of 1T″-ReS₂ with wrinkles 630 generated by UV exposure and smoothed by laser irradiation 622 at cryogenic temperature.

### Example 5

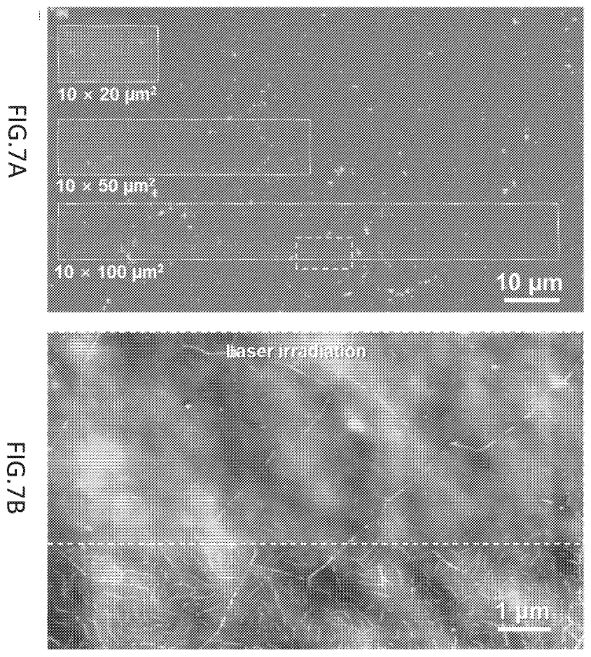

Put the full-film single-layer of 1T″-ReS₂ on the SiO₂ substrate. FIG. 7A shows the scanning electron microscope (SEM) of different flattened areas on the full-film 1T″-ReS₂. Place the substrate and full film single layer of 1T″-ReS₂ into the environment control chamber with a relative humidity (RH) level of 50-80% and expose under UV light for 180 seconds to mimic the photolithography process. Cool down the sample with a cooling speed of 2° C./min to −40° C. Focus the 514-nm laser beam onto the surface of ReS₂. Scan the focused laser beam to different area size of 10×20 μm², 10×50 μm² and 10×100 μm² to smooth the surface of single-layer ReS₂ as shown in FIG. 7B. FIG. 7B illustrates a zoomed in AFM topographic image of the edge between the flattened and the pristine surface.

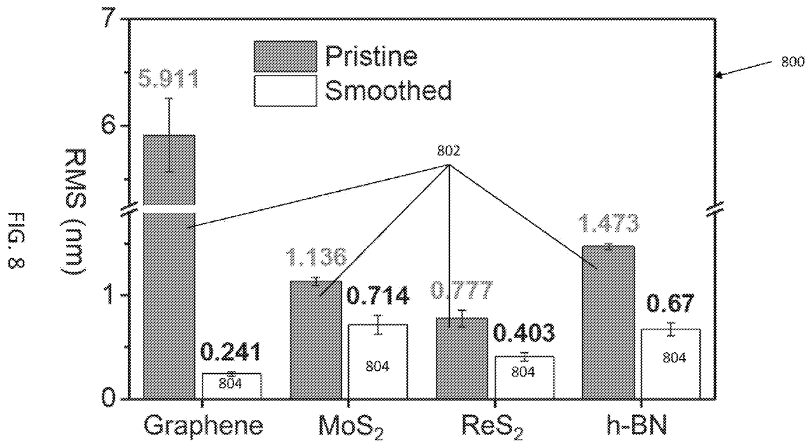

FIG. 8 shows the plot 800 of summarized root mean square (RMS) roughness of the control (pristine) surface and the surface after smoothing of graphene, MoS₂, ReS₂, and h-BN. As can be seen from plot 800 the smoothing method described herein achieves a high degree of smoothness on the 2D layered material surface. As shown in FIG. 8, the control (pristine) samples shown by graph 802 have a higher RMS value indicating rougher surface. The control devices i.e., devices not smoothed using the method 100, 200 are shown by plots 802 which show a larger RMS indicating more wrinkles. The smoothed devices using the method 100, 200 are shown by plots 804 which show a smaller RMS indicating less wrinkles.

The application of smoothing surfaces can also be used for modulation of electrical and optical properties of two-dimensional (2D) layered materials. Below is a description of testing and experimentation done to demonstrate the modulation of electrical and optical properties due to the application of a method for smoothing a surface of a 2D layered material positioned on a substrate according to the disclosure

The probe smoothing process allows a single-layer MoS₂ FET to improve electronic performance. Experimentation was performed to test Electronic Performance Enhancement of Single-Layer MoS₂ FET via Probe Scanning Surface Smoothing at High Humidity and Cryogenic Temperature.

To experimentally validate the efficacy of the disclosed method for smoothing as per the present disclosure, a surface smoothing treatment was performed on field-effect transistors (FETs) fabricated using chemical vapor deposition (CVD)-grown two-dimensional (2D) molybdenum disulfide (MoS₂). The results confirm that the high-humidity, cryogenic-temperature smoothing process effectively alleviates localized interfacial strain between the 2D semiconductor and metal contacts, leading to significant enhancement in device performance, as demonstrated in the following comparative analysis.

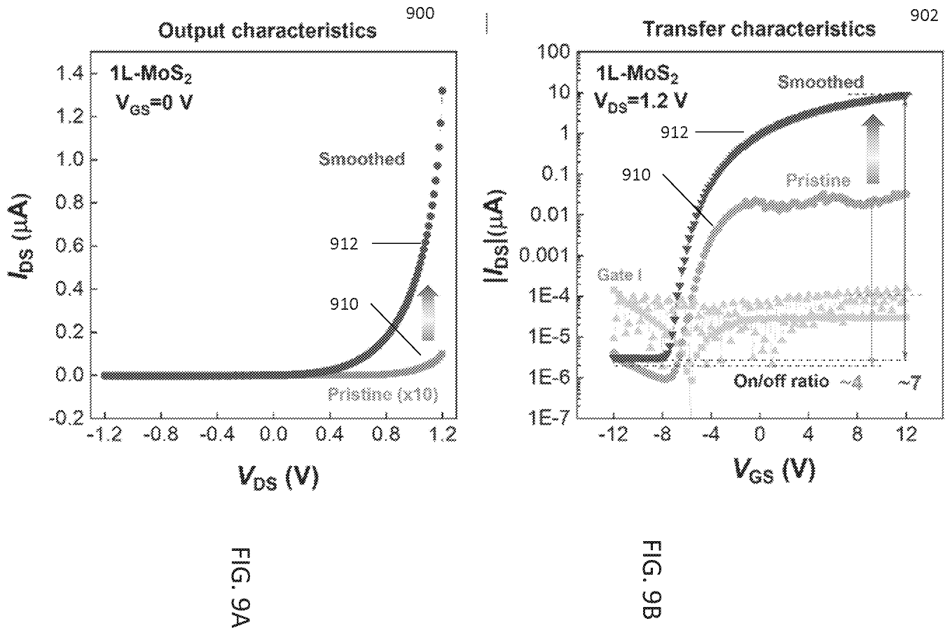

FIG. 9A and FIG. 9B illustrate, electronic performance of a smoothed 1L-MoS₂ FET device is compared to a control (pristine) 1L-MoS₂ FET with inherent contamination and wrinkled surfaces fabricated via conventional lithography and evaporation processes.

### Example 6

Firstly, a single-layer molybdenum disulfide (1L-MoS₂) field-effect transistor (FET) is fabricated on a 300 nm SiO₂/Si substrate using standard photolithography and metal evaporation processes, with a channel length of 2 μm and width of 5 μm. The electrical characteristics of this control (pristine) device are measured, as shown in the plot 900 of FIG. 9A and plot 902 of FIG. 9B. Curve 910 illustrates the electrical characteristics of the control (pristine) device.

Subsequently, the 1L-MoS₂ FET device was then subjected to the smoothing process according to the invention. The device is placed in an environmental control chamber and maintained at a relative humidity (RH) of 100% for 15 minutes. Following humidification, the sample is cooled to a cryogenic temperature of −10° C. at a controlled rate of 1° C./min. Approach a probe onto the surface of MoS₂ FET device. Move the probe to the device channel area with a speed of 2 um/s to smooth the surface of 1L-MoS₂ FET device.

Finally, the electrical characterization is repeated immediately after smoothing, as per plot 900 of FIG. 9A and plot 902 of FIG. 9B. Curves 912 show the electrical characteristics of the smoothed device. As shown in the plot the output characteristics (I_{DS}-V_{DS} curves) measured at a gate voltage (V_{GS} curve) of 0 V for the smoothed device show a significant increase in drain current. Furthermore, the transfer characteristics (I_{DS}-V_{GS} curve) measured at a drain-source voltage (V_{DS}) of 1.2 V, as shown in plot 902 of FIG. 9B. Plot 902 reveals a significant enhancement in FET device performance.

The on-state current increased markedly, while the off-state current remained low. Consequently, the current on/off ratio improved by three orders of magnitude for the smoothed device compared to pristine sample. Additionally, the subthreshold swing improved, indicating a reduction in interface trap states and more efficient gate control.

Electronic enhancement of Single-Layer Rhenium Disulfide (1L-ReS₂) field-effect transistors (FETs) via Laser irradiation surface smoothing at high humidity and cryogenic temperature was tested. Experimental validation was performed based on FETs fabricated using anisotropic two-dimensional (2D) semiconductors grown by chemical vapor deposition (CVD), specifically ReS₂, as pertinent to this invention. The results confirm that surface smoothing performed under conditions of high humidity and cryogenic temperature effectively mitigates localized strain near the contact interfaces between the 2D semiconductors and metal electrodes. Significantly, this post-fabrication surface treatment facilitates an Ohmic contacts between the 2D semiconductors and metals and achieves electronic performance enhancement.

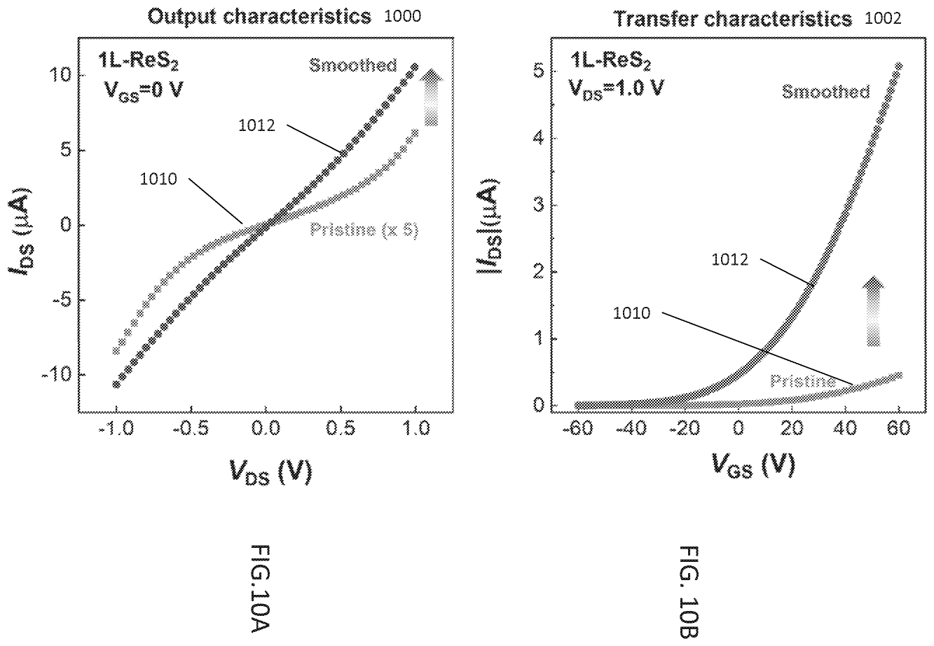

FIG. 10A and FIG. 10B illustrate plots of electronic performance of a smoothed 1L-ReS₂ FET device as compared to a control (pristine) 1L-ReS₂ FET with wrinkled surfaces induced by UV treatment.

### Example 7

Firstly, a single-layer rhenium disulfide (1L-ReS₂) field-effect transistor (FET) on a 300 nm SiO₂/Si substrate is intentionally treated with ultraviolet (UV) light for 180 seconds to simulate photolithography-induced surface damage and wrinkles. This forms the control (pristine) device. The electrical characteristics of this pristine device are measured and illustrated in plot 1000 and plot 1002 (as per FIG. 10A and FIG. 10B respectively). Curves 1010 illustrate the electrical characteristics of the control (pristine) device.

Subsequently, the wrinkled 1L-ReS₂ FET device is then subjected to the inventive smoothing protocol. The device is placed in an environmental control chamber set to a relative humidity (RH) of 80%. It is then cooled to a cryogenic temperature of −40° C. at a controlled rate of 2° C. per minute. A focused laser beam with a wavelength of 514 nm is directed onto the surface of the ReS₂ channel. The laser spot is scanned across the target area at a constant speed of 0.5 μm/s to thermally and physically smooth the surface.

Finally, the electrical performance is re-evaluated after the laser smoothing treatment. Curves 1012 illustrate the electrical characteristics of the smoothed 1L-ReS₂ FET device. As demonstrated in FIG. 10A, the output characteristics (I_{DS}-V_{DS} curve) measured at a gate voltage (V_{GS}) of 0 V show a dramatic improvement. The drain current of the smoothed device increased by more than an order of magnitude compared to the pristine device, whose data is shown magnified by a factor of 5 for visibility. This substantial current increase and the improved linearity at low V_{DS} indicate a significant reduction in series resistance and enhanced charge injection efficiency. Curves 1010 illustrates the performance of the control (pristine) device and curves 1012 illustrates the performance of the smoothed device.

Furthermore, the transfer characteristics (I_{DS}-V_{GS} curve) measured at a drain voltage (V_{DS}) of 1.0 V, as shown in FIG. 10B, reveal a critical performance transformation. The smoothed device exhibits a steeper subthreshold slope and a drastically increased on-state current, while maintaining effective gate modulation. The overall shape of the transfer curve shifts, indicating a favorable modification of the threshold voltage and a reduction in interface trap density.

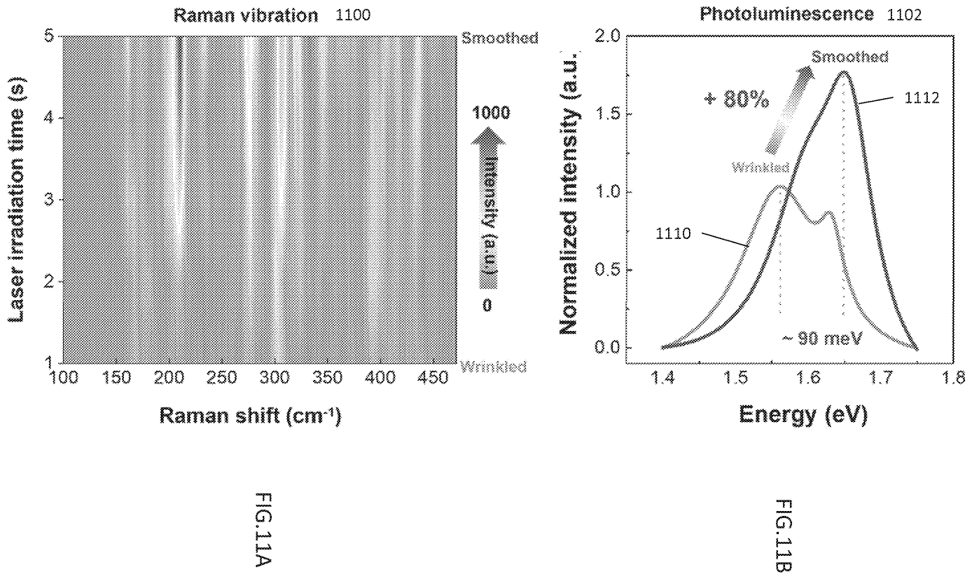

Optical properties modulation and enhancement in smoothed single-layer ReS₂ (1L-ReS₂) via laser irradiation at high humidity and cryogenic temperatures was tested. The functional benefits of the laser-assisted surface smoothing process were evaluated using Raman and photoluminescence (PL) spectroscopy. A 1L-ReS₂ flake on SiO₂/Si was intentionally treated with ultraviolet (UV) light to induce surface defects and wrinkles, followed by the disclosed laser smoothing under high relative humidity and cryogenic conditions, as shown in FIG. 11A and FIG. 11B. The treatment yields two distinct spectroscopic improvements, indicating both structural recovery and optoelectronic enhancement. Structural recovery via Raman spectroscopy shows the characteristic Raman vibration mode of ReS₂ with an intensity increase of approximately three orders of magnitude after smoothing, reflecting restored lattice periodicity and significantly reduced phonon scattering. Furthermore, optoelectronic enhancement via PL spectroscopy demonstrates the PL intensity increases 80%, accompanied by a 90 meV blue shift in the emission peak indicating strain relaxation.

Optical performance of a smoothed 1L-ReS₂ flake is compared to a control (wrinkled) 1L-ReS₂ with wrinkled surfaces induced by UV treatment.

### Example 8

Firstly, put the 1L-ReS₂ on a SiO₂/Si substrate into the environment control chamber with a relative humidity (RH) level of 80% and expose under UV light for 180 seconds to mimic the photolithography process. Then, the photoluminescence (PL) spectrum of this wrinkled 1L-ReS₂ is measured at room temperature using a 514 nm laser excitation shown in FIG. 11B.

Next, place the 1L-ReS₂ on a SiO₂/Si substrate into the environment control chamber with a relative humidity (RH) level of 80%. Cool down the sample with a cooling speed of 2° C./min to −40° C. Focus the 514-nm laser beam onto the surface of 1L-ReS₂. Scan the focused laser beam to the desired area with a speed of 1 um²/s to smooth one spot of 1L-ReS₂. The Raman spectrum is recording 1 s per time shown in plot 1100 in FIG. 11A.

Finally, the PL (photoluminescence) spectrum of the smoothed 1L-ReS₂ is measured at room temperature using a 514 nm laser excitation in shown plot 1102 if FIG. 11B (smoothed). Curve 1110 illustrates the performance of the control (wrinkled) device and curve 1112 illustrates the performance of the smoothed device. The wrinkled region exhibits a PL emission peak at a lower energy level, red-shifted by approximately 90 meV relative to the intrinsic band edge. This red shift is attributed to a strain-induced modification of the band alignment. Furthermore, the integrated PL intensity of the smoothed sample shows an increase of approximately +80%. This enhancement is a direct consequence of the recovery of favorable band alignment. The smoothing process achieves reducing or eliminating the band tail states and shallow traps, thereby suppressing non-radiative Shockley-Read-Hall recombination channels, and restoring a cleaner band edge, promoting more efficient radiative recombination of free excitons. The combined effect is a significant improvement in the internal quantum efficiency for light emissions.

Table 1 below illustrates a comparative analysis of the method according to the present disclosure labelled (our invention) and other methods to remove wrinkles. The methods are tested on various materials that they are particularly suited for. The results in Table 1 show that the method for smoothing a surface according to the present disclosure (e.g., method 100 or 200) provides a cheaper and more effective solution The method according to the present disclosure is also universally applicable to any substrate and any 2D layered material. The method according to the present disclosure results in 100% wrinkle removal. The results in table 1 clearly illustrate the superior performance of method 100, 200 in removing wrinkles and maintaining effectiveness of the smoothed device.

TABLE 1

| Surface | Materials | | | | | | | Cost |
|---|---|---|---|---|---|---|---|---|
| smoothing | (with | | | | | Wrinkle | | ($/ |
| methods | reference) | Temp. | Environment | Area | Resolution | removable | Time | cm²) |
| Thermal | SiO2 | 600~800° C. | N₂ gas | 700 × 700 | 700 × 700 | Yes (large | 30~60 | 4~5 |
| annealing | membrane- | | | μm² | μm² | wrinkles | min | |
| | Thin films | | | | | only: | | |
| | [Symposium | | | | | Height | | |
| | on Design, | | | | | >10 μm; | | |
| | Test, | | | | | width | | |
| | Integration | | | | | >200 μm) | | |
| | & Packaging | | | | | | | |
| | of MEMS | | | | | | | |
| | and MOEMS | | | | | | | |
| | (DTIP), 2020, | | | | | | | |
| | pp. 1-4] | | | | | | | |
| Thermal | Graphene on | 250~800° C. | High vacuum | 1 × 1 | 1 × 1 | Yes | 8~12 | 6~8 |
| annealing | SiO2-2D | | | cm² | cm² | (Small | hrs | |
| | materials | | | | | wrinkles | | |
| | [ACS nano | | | | | only: | | |
| | 14.2 (2020): | | | | | height | | |
| | 2137-2144] | | | | | ≤1 nm) | | |
| Paraffin- | CVD-grown | 80° C. | Inert gas | 15 × 15 | 15 × 15 | Yes | 24~48 | 10~12 |
| enabled | graphene & | | | mm² | mm² | (Small | hrs | |
| transfer | Paraffin | | | | | wrinkles | | |
| | coating [Nat. | | | | | only: | | |
| | Comm. 10.1 | | | | | height | | |
| | (2019): 867] | | | | | ≤1 nm) | | |
| Nano- | WS₂ on h- | RT | Ambient | 15 × 15 | ~1 nm | No | 10~60 | 2~3 |
| Squeegee | BN; MoSe₂- | | | μm² | | | min | |
| | WSe₂ [ACS | | | | | | | |
| | appl. mater. | | | | | | | |
| | & interfaces. | | | | | | | |
| | 10.12 | | | | | | | |
| | (2018): | | | | | | | |
| | 10379 | | | | | | | |
| | 10387] | | | | | | | |
| Nano- | WS₂ [ACS | 600~1100° C. | Inert gas | 50 × 50 | ~10 nm | No | 10~60 | 8~10 |
| ironing | appl. mater. | | | μm² | | | min | |
| | & interfaces. | | | | | | | |
| | 16.24 | | | | | | | |
| | (2024): | | | | | | | |
| | 31738- | | | | | | | |
| | 31746] | | | | | | | |
| (Examples | Universal | 0~−10° C. | N₂ gas | 150 × 150 | ~0.2 nm | Yes | 10~60 | ~1 |
| of the | | | containing | μm² | | (100% | min | |
| Invention) | | | 80~100% | | | removed | | |
| Cryogenic | | | relative | | | all types | | |
| smoothing | | | humidity | | | of | | |
| by | | | | | | wrinkles | | |
| scanning | | | | | | in the | | |
| probe | | | | | | effective | | |
| | | | | | | area) | | |
| (Examples | Universal | 0~−20° C. | N₂ gas | 10 × 10 | ~1 μm | Yes | 5~30 | ~0.2 |
| of the | | | containing | cm² | | (100% | min | |
| Invention) | | | 80~100% | | | removed | | |
| Cryogenic | | | relative | | | all types | | |
| smoothing | | | humidity | | | of | | |
| by laser | | | | | | wrinkles | | |
| irradiation | | | | | | in the | | |
| | | | | | | effective | | |
| | | | | | | area) | | |

The method or methods described may be adapted for scalable smoothing surfaces of 20 layered materials on solid substrates. The smoothing process works at high humidity and cryogenic temperature. A solid probe is used to move over (i.e., scan over) the surface to eliminate wrinkles and contaminants on the nano- to hundreds-micro-scale surface. A laser (e.g., a visible frequency laser) is used to irradiate to eliminate wrinkles on the micro- to wafer-scale surface. Therefore, the new method can effectively remove 100% of wrinkles in the area from nano- to wafer-scale.

The smoothing method 100, 200 as described is advantageous because a specific smoothing process can be selected depending on the target area that needs smoothing. This allows for an optimal smoothing to be achieved depending on the size of the target area. A solid probe is used to mechanically smooth wrinkles in target areas that are smaller e.g., a target area of less than 100 μm², and a laser irradiation based smoothing process is selected for target areas of greater than 1 μm². Optionally, both smoothing processes may be applied to ensure most if not all wrinkles are removed.

The disclosed method 100, 200 can effectively remove 100% of wrinkles in the area from nano- to wafer-scale.

The key to successfully removing wrinkles of 2D layered materials on substrates is to overcome the friction caused by the van der Waals (vdW) interplay between 2D layered materials and underlying substrates. The frictionless 2D confined ice layer is spontaneously generated from the high humidity environment between the 2D layered material and the substrate, which reduces friction between the 2D layered materials and underlying substrates. Wrinkles can be easily removed by a minimal external force applied via a nano-solid probe scanning over the surface and/or external strain from rapid thermal relaxation via laser irradiation due to the low friction created by the ice layer. The cryogenic temperature promotes the generation of 2D confined ice layers and enhances thermal relaxation under laser irradiation.

The current technique can remove 100% of wrinkles on semimetal hexagonal graphene, 2H phase molybdenum disulfides (2H-MoS₂), distorted 1T′ phase rhenium disulfides (1T″-ReS₂), and insulating hexagonal boron nitrides (h-EN) on silicon oxides and mica substrates prepared by different methods including as-grown and transferred samples.

Any reference to prior art contained herein is not to be taken as an admission that the information is common general knowledge, unless otherwise indicated.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method for smoothing a surface of a two-dimensional (2D) layered material positioned on a substrate, the method comprising:
positioning the 2D layered material on a substrate,
exposing the 2D layered material and the substrate to an environment that creates a low friction layer between the 2D layered material and the substrate,
applying a smoothing process to the surface of the 2D layered material; and,
wherein the low friction layer reduces or overcomes van der Waals force between the 2D layered material and the substrate to facilitate removal of wrinkles formed in the 2D layered material.

2. The method of claim 1, wherein the environment that creates the low friction layer is an environment with a relative humidity sufficient to intercalate water molecules between the 2D layered material and the substrate.

3. The method of claim 2, wherein the environment is at a temperature sufficient to freeze the intercalated water molecules into an ice layer confined between the 2D layered material and the substrate.

4. The method of claim 3, comprising:
placing the 2D layered material and the substrate in an environment control chamber,
introducing moisture into the environment control chamber to establish a relative humidity sufficient to intercalate the water molecules between the 2D layered material and the substrate,
cooling the 2D layered material from a first temperature to a second temperature to freeze the intercalated water molecules into a confined ice layer at an interface between the 2D layered material and the substrate; and,
wherein the second temperature is a cryogenic temperature.

5. The method of claim 4, wherein introducing moisture comprises introducing a wet nitrogen gas into the environment control chamber to control the relative humidity in the environment control chamber; and, wherein the relative humidity established in the environment control chamber is in the range of 50% to 100%; and, the 2D layered material and the substrate are maintained in the environment with relative humidity for a period of time sufficient to ensure intercalation of water molecules into an interface between the 2D layered material and the substrate.

6. The method of claim 5, wherein the wet nitrogen gas is introduced into the environment control chamber at a flow rate in a range of 0.05 L/min to 1 L/min; and, the method further comprises maintaining the 2D layered material in the relative humidity level for between 10 minutes to 3 hours to intercalate water molecules between the 2D layered material and the substrate.

7. The method of claim 4, wherein the cryogenic temperature is in the range of 0° C. to −250° C. or 0° C. to −50° C.

8. The method of claim 4, wherein the step of cooling is performed at a cooling rate in a range of 1° C./min to 4° C./min.

9. The method of claim 1, wherein the smoothing process comprises moving a solid probe over a target area of the surface of the 2D layered material to apply a mechanical force to the 2D layered material.

10. The method of claim 9, wherein the mechanical force applied by the solid probe is in the range of 1 nN to 100 nN; and, wherein the solid probe is moved at a speed in range of 2 μm/s to 10 μm/s.

11. The method of claim 10, wherein the solid probe is selected from a group consisting of silicon probe, diamond probe or a metal-coated silicon probe.

12. The method of claim 10, wherein the target area for moving the solid probe is in the range of 1 nm² to 100 μm².

13. The method of claim 1, wherein the smoothing process comprises irradiating a target area of the surface of the 2D layered material with a laser.

14. The method of claim 13, wherein the laser is applied with a power in a range of 0.5 mW to 15 mW, wherein the laser is scanned across the surface at a speed in a range of 0.5 μm to 2 μm on the surface of the 2D layered material; and, wherein the target area for irradiating with the laser ranges from 0.5 μm² to a full wafer scale.

15. The method of claim 1, wherein the smoothing process is selected based on a size of a target area that requires smoothing, wherein a solid probe based smoothing process is selected for a target area of less than 100 μm² and a laser irradiation based smoothing process is selected for target areas of greater than 1 μm².

16. The method of claim 1, wherein the method eliminates 100% of wrinkles on the surface of the 2D layered material positioned on the substrate.

17. The method of claim 1, wherein the method comprises the step of selecting one of two smoothing processes based on a size of target area that requires smoothing, wherein a first smoothing process applies a mechanical force to the target area, and a second smoothing process applies thermal irradiation to the target area.

18. The method of claim 17, wherein the method comprises the steps of:
selecting one of two smoothing processes based on a size of target area that requires smoothing, wherein a first smoothing process applies a mechanical force to the target area, and a second smoothing process applies thermal irradiation to the target area; and,
applying the selected smoothing process to the surface of the 2D layered material.

19. The method of claim 18, wherein applying the smoothing process to the surface of the 2D layered material causes removal of one or more wrinkles from the surface of the 2D layered material.

20. The method of claim 13 wherein the wavelength of the laser used in laser irradiation is in the range of visible to near IR, the wavelength being between 400 nm to 800 nm.
